(19) United States
(12) Patent Application Publication
(10) Pub. No.: US 2002/0081978 A1
(43) Pub. Date: Jun. 27, 2002

(54) Antenna RF transmission safety system and method

(76) Inventors: Peter Hou, Germantown, MD (US); Fayez Hyjazie, Germantown, MD (US); Thomas Jackson, Frederick, MD (US); Stan Kay, Rockville, MD (US); Jack Lundstedt, Monrovia, MD (US); Doug Ricker, Clarksburg, MD (US); Ken Sahai, North Potomac, MD (US); James Zawlocki, Gaithersburg, MD (US); Walter R. Kepley, Gaithersburg, MD (US)

Correspondence Address: Hughes Electronics Corporation, Patent Docket Administration, P.O. Box 956, Bldg. 1, Mail Stop A109, El Segundo, CA, 90245-0956, US

(21) Appl. No.: 09/828,733

(22) Filed: Apr. 9, 2001

Related U.S. Application Data
(60) Provisional application No. 60/244,815, filed on Oct. 31, 2000.

(51) Int. Cl. H04B 17/00

(52) U.S. Cl. 455/67.1; 455/13.4

(57) ABSTRACT

An RF emission hazard zone of an RF transceiver is controlled to ensure that RF energy density limits for humans is not exceeded when a human body part enters the RF hazard zone near an antenna reflector and feedhorn. In a first aspect, a transmitter duty cycle is reduced to effectively reduce the average power transmitted from the antenna whenever a signal level of a received signal is reduced below a threshold value. The reduction in average transmitter power reduces the RF emission hazard zone near the antenna, and limits the exposure of any person who has intruded into the hazard zone. In a second aspect, the transmitter is disabled whenever a received signal is affected so that signal quality, bit-energy-to-noise ratio (E_{b}/Nₒ), synchronized state in a demodulator, lock condition in a FLL, or received signal strength are degraded, indicating that a human has intruded into the RF hazard zone.

### CROSS-REFERENCE TO RELATED APPLICATIONS

This application claims the benefit under 35 U.S.C. § 119(e) of U.S. Provisional Application of Hou et al. entitled “Antenna RF Transmission Safety Mechanism”, serial No. 60/244,815, filed on Nov. 1, 2000, the entire contents being incorporated herein by reference.

### BACKGROUND OF THE INVENTION

1. Field of the Invention

This invention relates generally to a safety system and method used in connection with controlling radio-frequency (RF) emissions from an antenna when a portion of a human body moves into a hazardous emission zone of the antenna in which the RF power density exceeds safety limits established for human exposure.

2. Description of the Related Art

Radio-frequency electromagnetic energy emitted from an antenna is a safety concern when the power density exceeds a certain level. Federal Communication Commission (FCC) rules require transmitting facilities to comply with RF exposure guidelines. The limits established in the guidelines are designed to protect the public health with a margin of safety. These limits have been endorsed by federal health and safety agencies such as the Environmental Protection Agency (EPA) and the Food and Drug Administration (FDA). Most electro-magnetic facilities create maximum exposures that are only a small fraction of the limits. Moreover, the limits themselves are many times below levels that are generally accepted as having the potential to cause adverse health effects.

The FCC's limits for maximum permissible exposure (MPE) to RF emissions depend on the frequency or frequencies that a person is exposed to. Different frequencies may have different MPE levels.

Exposure to RF energy has been identified by the FCC as a potential environmental factor that must be considered before an emitting facility, operation of an emitter, or transmitter can be authorized or licensed. The FCC's requirements dealing with RF exposure can be found in Part 1 of its rules at 47 C.F.R. § 1.1307(b). The exposure limits themselves are specified in 47 C.F.R. § 1.1310 in terms of frequency, field strength, power density and averaging time. Facilities and transmitters licensed and authorized by the FCC must either comply with these guidelines or else an applicant must file an Environmental Assessment (EA) with the FCC. In practice, however, a potential environmental RF exposure problem is typically resolved before an EA would become necessary. Therefore, compliance with the FCC's RF guidelines constitutes a de facto threshold for obtaining FCC approval to construct or operate a station or transmitter. The FCC guidelines are based on exposure criteria recommended in 1986 by the National Council on Radiation Protection and Measurements (NCRP) and on the 1991 standard developed by the Institute of Electrical and Electronics Engineers (IEEE), and later adopted as a standard by the American National Standards Institute (ANSI/IEEE C95.1-1992).

The FCC's guidelines establish separate MPE limits for “general population/uncontrolled exposure” and for “occupational/controlled exposure.” The general population/uncontrolled limits set the maximum exposure to which most people may be subjected. People in this group include the general public who are not associated with the installation and maintenance of the transmitting equipment. Higher exposure limits are permitted under the “occupational/controlled exposure” category, but only for persons who are exposed as a consequence of their employment (e.g., wireless radio engineers or technicians). To qualify for the occupational/controlled exposure category, exposed persons must be made fully aware of the potential for exposure (e.g., through training), and they must be able to exercise control over their exposure. In addition, people passing through a location, who are made aware of the potential for exposure, may be exposed under the occupational/controlled criteria. The MPE limits adopted by the FCC for occupational/controlled and general population/uncontrolled exposure incorporate a substantial margin of safety and have been established to be well below levels generally accepted as having the potential to cause adverse health effects.

Determing whether a potential health hazard could exist with respect to a given transmitting antenna is not always a simple matter. Several factors must be considered in making that determination. They include, but are not limited to, the frequency of the RF signal being transmitted, the operating power of the transmitting station, the actual power radiated from the antenna, how long a person is exposed to the RF signal at a given distance from the antenna, and exposure from other RF emissions located in the area.

The MPE limits vary by frequency because of the different absorptive properties of the human body at different frequencies when exposed to whole-body RF fields. 47 C.F.R. § 1.1310 establishes MPE limits in terms of “electric field strength,” “magnetic field strength,” and “far-field equivalent power density” (power density). For most frequencies used by wireless and satellite communication services, the most relevant measurement is power density. The MPE limits for power density are given in terms of “milliwatts per square centimeter” or mW/cm². In terms of power density, for a given frequency the FCC MPE limits can be interpreted as specifying the maximum rate that energy can be transferred (i.e., the power) to a square centimeter of a person's body over a period of time (either 6 or 30 minutes). In practice, however, since it is unrealistic to measure separately the exposure of each square centimeter of the body, actual compliance with the FCC limits on RF emissions should be determined by “spatially averaging” a person's exposure over the projected area of an adult human body.

Electric field strength (|E|) and magnetic field strength (|H|) are used to measure “near field” exposure. At frequencies below 300 MHz, these are typically the more relevant measures of exposure, and power density values are given primarily for reference purposes. However, evaluation of far-field equivalent power density exposure may still be appropriate for evaluating exposure in some such cases. For frequencies above 300 MHz, only one field component need be evaluated, and exposure is usually more easily characterized in terms of power density. Transmitters and antennae that operate at 300 MHz or lower include radio broadcast stations, some television broadcast stations, and certain personal wireless service facilities (e.g., some paging stations). Most personal wireless services, including all cellular and PCS, as well as some television broadcast stations and microwave communications, including satellite communications, operate at frequencies above 300 MHz.

As noted above, the MPE limits are specified as time-averaged exposure limits. This means that exposure can be averaged over the identified time interval (30 minutes for general population/uncontrolled exposure or 6 minutes for occupational/controlled exposure). However, for the case of exposure of the general public, time averaging is usually not applied because of uncertainties over exact exposure conditions and difficulty in controlling time of exposure. Therefore, the typical conservative approach is to assume that any RF exposure to the general public will be continuous. The FCC's current limits for exposure at different frequencies are shown in Table 1.

Currently, for frequencies in the microwave band, the Federal Communications Commission (FCC) has established an exposure safety limit for the general public of 1 mW/cm², averaged over a 30-minute period.

TABLE 1
FCC Limits for Maximum Permissible Exposure (MPE)

| | | | | |
|---|---|---|---|---|
| | Electric | | | Averaging |
| | Field | Magnetic Field | Power | Time \|E\|², |
| Frequency (f) | Strength | Strength (H) | Density (S) | \|H\|² or S |
| Range (MHz) | (E) (V/m) | (A/m) | (mW/cm²) | (minutes) |

(A) Limits for Occupational/Controlled Exposure

| | | | | |
|---|---|---|---|---|
| 0.3-3.0 | 614 | 1.63 | (100)* | 6 |
| 3.0-30 | 1842/f | 4.89/f | (900/f²)* | 6 |
| 30-300 | 61.4 | 0.163 | 1.0 | 6 |
| 300-1500 | — | — | f/300 | 6 |
| 1500-100,000 | — | — | 5 | 6 |

(B) Limits for General Population/Uncontrolled Exposure

| | | | | |
|---|---|---|---|---|
| 0.3-1.34 | 614 | 1.63 | (100)* | 30 |
| 1.34-30 | 824/f | 2.19/f | (180/f²)* | 30 |
| 30-300 | 27.5 | 0.073 | 0.2 | 30 |
| 300-1500 | — | — | f/1500 | 30 |
| 1500-100,000 | — | — | 1.0 | 30 |

f = frequency in MHz
*Plane-wave equivalent power density

For most common reflector type of antennae used for satellite earth terminal transmission to a satellite, the transmit power density often exceeds this safety limit in the area between the feedhorn and reflector, and sometimes in the near-field a very short distance in front of the antenna. This poses a potential safety hazard, especially for children who can not read warning signs or labels, and who may intentionally or unintentionally place themselves in the emission hazard areas, and poses a safety hazard for small animals, such as cats, squirrels, birds, etc.

Conventional approaches used to reduce RF emission exposure hazard include placing the antenna out of physical reach under normal circumstances, for example, on a roof top or on top of a pole at least six feet off the ground, or using an enclosure such as a radome that limits human access, or access by small animals such as birds, cats, and squirrels.

Unfortunately, these protective measures can be defeated relatively easily by a determined person who either climbs up the antenna mast or on the roof, or who intentionally or unintentionally breaks the protective radome and receives exposure to RF energy at a density level greater than that specified by the limits discussed above. To counter this possibility, additional hardware or structure around the antenna is necessary, or other restrictions on antenna mounting sites and methods must be imposed to render the installation safer, all at additional cost and inconvenience.

A more reliable approach from a safety viewpoint would be to control the actual transmission of the RF energy from the feedhorn or antenna when intrusion into the hazardous zone is made. However, the known approaches to solving the problem of human exposure to RF energy in the antenna hazard zone does not make use of such controls, and instead merely relies upon physical mounting or shielding.

What is needed, therefore, is a relatively low-cost, inexpensive, and reliable system and method for automatically reducing the RF power transmitted from an antenna when a human either intentionally or unintentionally intrudes into the hazardous emission zones of the antenna. What is also needed is a system and method for incrementally reducing the RF power as the blockage progressively worsens. What is also needed is a system and method for disabling the RF power transmitted when substantial blockage of the antenna is encountered.

### SUMMARY OF THE INVENTION

The present invention solves at least one of the aforementioned problems of intentional or unintentional intrusion into a hazardous emission zone of an antenna by a human, including total blockage of the antenna, and mitigates the associated RF emission hazard resulting from such intrusion or blockage.

A first aspect of the invention embodies a system and method which controls the RF hazard zone by limiting the transmit duty cycle for any given maximum transmitter power, thereby limiting the average power in any give 30-minute period. For example, if a 50% duty cycle is imposed on a 2-W maximum transmitter, then its hazard zone will be the same as that of a 1-W maximum transmitter operating at 100% duty cycle. As a second example, a reduction of duty cycle from 100% to 25% will reduce the size of the hazard zone by 6 dB, for the same transmitter.

In this aspect of the invention, the average RF transmitted power from an antenna is automatically reduced when a portion of a human body moves into the RF hazard zone of the antenna (in the close vicinity of the antenna) in which the RF power density exceeds safety limits for human exposure. This is achieved by detecting changes in the received power level from a distant source, for example, a satellite, which is relatively weak and therefore, has a safe level of RF energy. This RF energy is present in the environment regardless of the presence of the antenna of interest. The detected reduction in received power level is used to indicate the intrusion of a foreign object into the RF hazard zone, for example, portions of a human body. The underlying physical principle is that any intrusion of human body of body parts in the vicinity of the antenna or the feedhorn will necessarily block part of the antenna aperture or the reflector/feedhorn pathway, thus causing a reduction in the received power.

A second aspect of this invention directed to a system and method for controlling an RF hazard zone similarly detects the intrusion of a human body or body parts into a prescribed auto-shutoff zone by continually monitoring the received power level. When the reduction in received power reaches a determined level, the mechanism quickly disables the transmitter by triggering shutoff of the transmit power, typically in a fraction of a second, for example, an output power reduction of at least 50 dB within 25 micro-seconds. The shutoff zone, which is determined by the reduction in received power level at which the shutoff is triggered, may completely enclose the hazard zone, to ensure absolute safety.

There are several levels of hardware and software that may be used to fail-safe the transmitter, and to automatically disable transmission should any of the signal parameters or attributes used indicate a degradation of performance.

For example, the system may determine and evaluate the following exemplary signal parameters or attributes, and disable the transmitter if one or more of the parameters indicate that the received signal is degraded, and that a foreign object may have intruded into the hazard zone or auto-shutoff zone:

(1) Receive signal lock, which detects the presence of a received digital signal stream;

(2) Demodulation lock or synchronization of the receiver demodulator, which indicates the integrity of the digital signals;

(3) Intermediate Frequency Module (IFM) lock, which indicates the proper strength of the received signals;

(4) Frequency locked loop (FLL) lock, indicating that the receiver front-end is properly synchronized to the received signal; or

(5) The bit-energy-to-noise ratio E_{b}/Nₒ is determined and compared to a threshold value, below which the transmitter is disabled.

All of the above fail-safe mechanisms, or others not discussed but known in the art, may be set and fine tuned in the design to tailor the size and sensitivity of the “shutoff zone”. When the shutoff zone completely encloses the hazard zone for a prescribed minimum size of human body parts, fail-safe automatic shutoff of the transmitter, and therefore complete safety, may be achieved.

The present invention has a number of features that distinguish it over conventional safety approaches that attempt to limit exposure of humans to RF emissions. For example, the method and system of the present invention uses an automated, fail-safe approach to reduce or eliminate the RF emission hazard associated with the RF antenna, whereas conventional approaches to solving this problem have relied only upon physical barriers or additional costly and potentially heavy structure to protect humans from deliberate or inadvertent exposure to RF emissions.

These and other objects of the present application will become more readily apparent from the detailed description given hereinafter. However, it should be understood that the detailed description and specific examples, while indicating preferred embodiments of the invention, are given by way of illustration only, since various changes and modifications within the spirit and scope of the invention will become apparent from this detailed description to those skilled in the art.

### BRIEF DESCRIPTION OF THE DRAWINGS

The features and advantages of the invention will be more readily understood upon consideration of the following detailed description of the invention, taken in conjunction with the accompanying drawings in which:

FIG. 1 depicts a typical satellite communication system in which the system and method of the present invention may be used;

FIG. 2 provides a representation of the antenna RF hazard zone of the present invention;

FIG. 3 provides a block diagram representation of a remote station transceiver of the present invention;

FIGS. 4A and 4B provide alternative embodiments of the interface between the receiver and control processor; and

FIG. 5 provides an example of a word structure of a multi-bit control word used in one embodiment of the interface between the receiver and control processor.

### DETAILED DESCRIPTION OF THE INVENTION

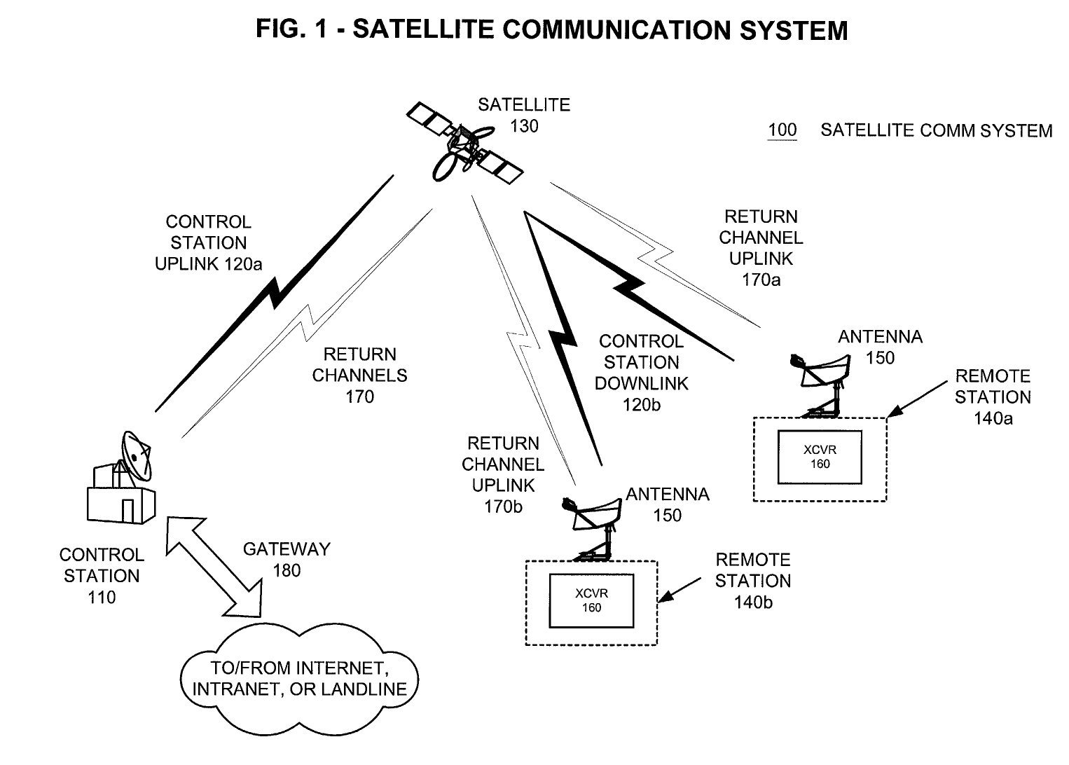

A preferred embodiment of the method and system of providing control of an RF emission hazard zone is described below. Referring to FIG. 1, a typical two-way satellite communication system that may employ the method and system of the present invention is shown.

Control station 110 provides control station uplink 120a to satellite 130 which, in turn, provides control station downlink 120b to one or more remote stations 140 (140a, 140b, etc.). Control station uplink/downlink 120a/120b, for example, may use a time-division multiple access (TDMA) type signal, or other signal modulation techniques appropriate to satellite communications. Control station uplink 120a may be provided in a “broadcast” mode for receipt by a large number of users, or may be directed to one or a smaller number of dedicated users. Remote station 140 receives control station downlink 120b through antenna 150, and then control station downlink 120b is further provided to transceiver (XCVR) 160 for processing.

Return channel uplink 170a represents a return channel path from remote station 140 back to control station 110 through satellite 130, and may use any appropriate modulation technique, for example, TDMA, the preferred modulation technique, or other types of modulation schemes, such as code-division multiple access (CDMA) or frequency-division multiple access (FDMA), or other appropriate modulation schemes. Preferably the transmit frequency of return channel uplink, 170a is at a different frequency than control station downlink 120b. Information contained in return channel 170 may be processed within control station 110, or may be further provided to or from the internet, an intranet, or a landline (telephone line) through gateway 180.

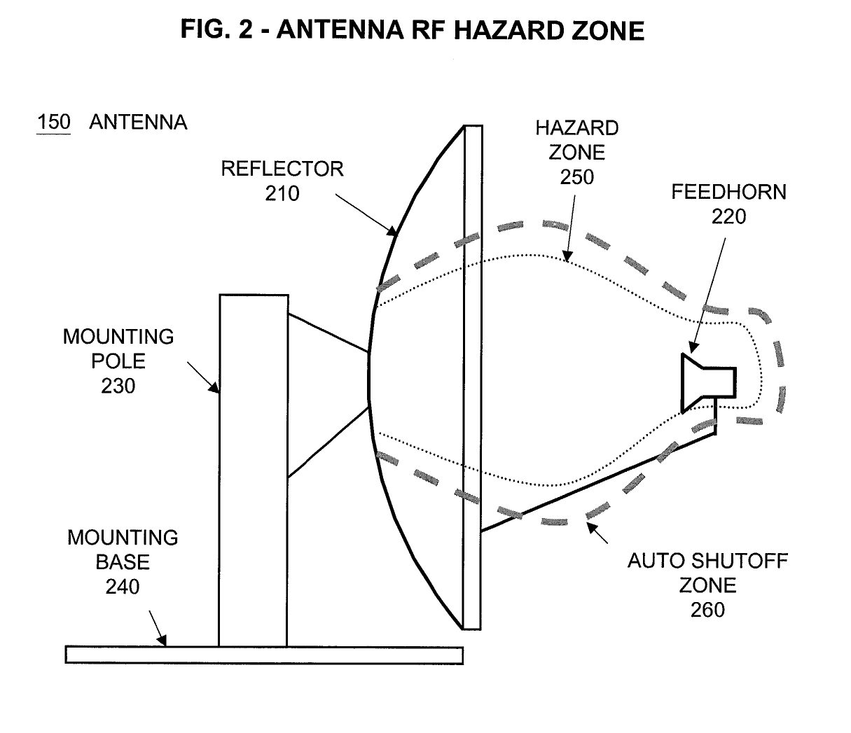

Turning to FIG. 2, antenna 150 is depicted. Antenna 150 includes reflector 210 and feedhorn 220 which are appropriately arranged with respect to each other for directing and receiving RF energy, and which are collectively attached to mounting pole 230 and mounting base 240. In receive mode, reflector 210 collects RF energy from a far-away source, for example satellite 130, and focuses it onto feedhorn 220. In transmit mode, feedhorn 220 spreads the RF energy in a prescribed manner onto reflector 210 which in turn collimates the energy to form a narrow beam that is aimed at satellite 130. At distances close to feedhorn 220, the transmit RF power density level can be relatively high, for example greater than 1 mW/cm² when averaged over a 30 minute period, which defines hazard zone 250, and which represents an area wherein the maximum power density exposure limit for humans is exceeded. FIG. 2 further shows auto-shutoff zone 260, which completely encompasses hazard zone 250, and which represents an area provided as a safety margin with respect to hazard zone 250. In the area between auto-shutoff zone 260 and hazard zone 250, the power density exposure is less than the maximum permitted limits, nonetheless, intrusion into auto-shutoff zone 260 is also used into the present invention as an additional safety factor.

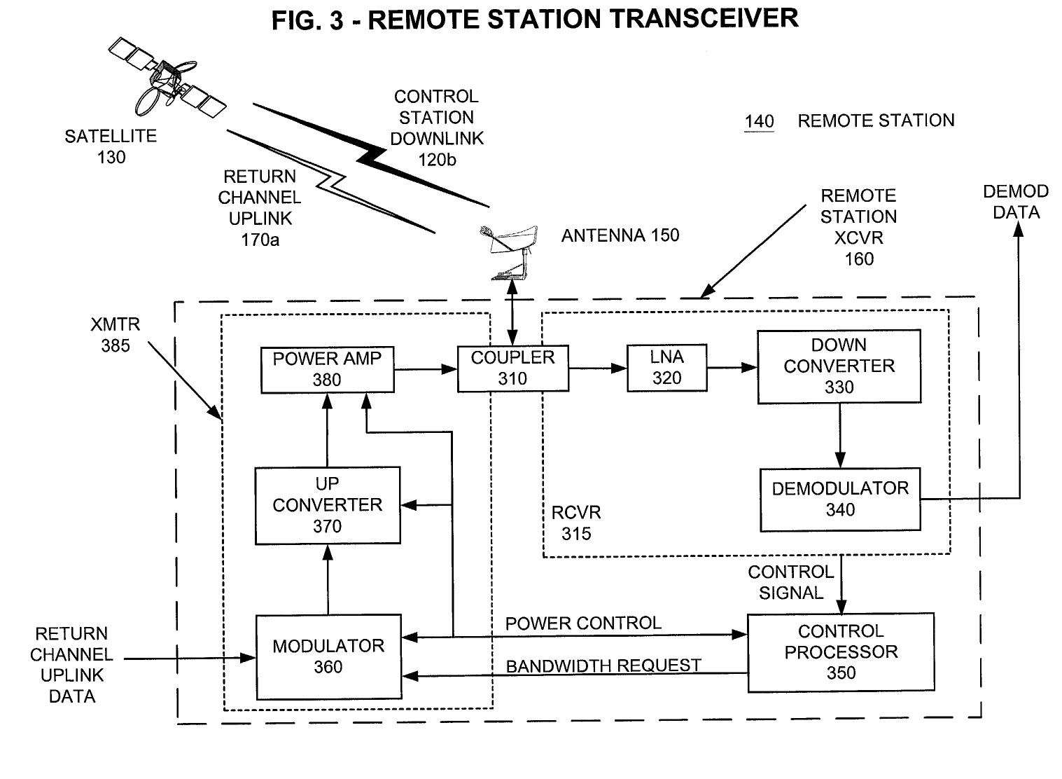

With respect to FIG. 3, details of remote station transceiver 160 in remote station 140 are shown. Control station downlink 120b is received by antenna 150 and provided to coupler 310. Coupler 310 is used to separate transmit and receive signals to/from antenna 150 and, in a preferred embodiment, for example, may be implemented as a diplexer or waveguide filter. The signal from an output port of coupler 310 is provided to receiver 315, for example, an input of low-noise amplifier (LNA) 320, which boosts the received signal while reducing, to the extent possible, the addition of further noise during the amplification process. LNA 320 provides the amplified signal to down converter 330, to translate the received signal, at an RF frequency, to a lower intermediate frequency (IF) which can be more readily processed in receiver 315. In a preferred embodiment, the signal at IF is provided to demodulator 340, which demodulates the received signal to provide demodulated data at baseband.

Receiver 315 generates at least one control signal provided to control processor 350. Under the direction of the control signal from receiver 315, control processor 350 controls transmitter 385, which includes modulator 360, up-converter 370 and power amplifier 380.

Return channel uplink data is provided to modulator 360 at baseband, and modulator 360 formats the uplink data in the proper manner for the particular modulation scheme being used, for example, framing of data and control words, application of forward error correction (FEC), and determining the amount of bandwidth (BW), i.e. timeslots, to be requested from control station 110, in an exemplary implementation using TDMA. Modulator 360 may also convert the baseband signals to another IF for ease of processing, or to achieve commonality of signal formats and frequencies within transmitter 385. Modulator 360 provides the baseband or IF signal to up-converter 370, which translates the modulator output to an RF signal (at a relatively low level), to a frequency which is intended to be transmitted.

Power amplifier 380 boosts the signal level of the RF signal to a power level sufficient for transmission, and provides the boosted or amplified RF signal to an input port of coupler 310 which then, through waveguide filtering, for example, provides the amplified RF signal to feedhorn 220 and reflector 210 of antenna 150. Thus, the amplified RF signal is propagated from antenna 150 toward satellite 130.

Operation of the system and method of the present invention are now discussed with respect to FIGS. 3-5.

As mentioned previously, the first aspect of the invention controls the RF hazard zone by limiting the transmit duty cycle for any given maximum transmitter power. The average RF transmitted power from antenna 150 is reduced when a portion of a human body or foreign object moves into RF hazard zone 250 of antenna 150. This is achieved by detecting, in receiver 315, changes in the received power level of control station downlink 120b from satellite 130.

If the received power level is reduced below a first threshold value, for instance, the received power level may still be adequate to allow receiver 315 to normally function. This could correlate to only a small blockage between feedhorn 220 and reflector 210, for example. In response to this first reduction in the received power level, the transmitter duty cycle may, for example, be reduced from unity (i.e. 100% duty cycle or duty factor) or a relatively large duty cycle, e.g. 80%, to a lower duty cycle, for example, 50%. As an example, if a 50% duty cycle is imposed on a 2-W maximum transmitter, then its hazard zone 250 will be the same as that of a 1-W maximum power transmitter operating at 100% duty cycle, and the size of the hazard has thus effectively been reduced by 3 dB.

As a second example, if the received signal power is reduced even further, then greater blockage or intrusion into hazard zone 250 may be presumed to have occurred. In response, an additional reduction of duty cycle from 50% to 25% may be used to reduce the size of the hazard zone by an additional 3 dB, for the same transmitter 385. Such step-wise reductions in power such as these could be progressively applied as the received power level lessens (but still remains usable) over time, indicating further levels of intrusion or blockage between feedhorn 220 and reflector 210. In a preferred embodiment using TDMA techniques, allocation of bandwidth through slot assignment is used to vary the average power depending on a detected intrusion into hazard zone 250; the peak transmitter power is not changed to ensure that adequate signal energy reaches satellite 130 during the time-slots in which transmission is authorized. However, the present invention could alternatively reduce the peak transmitter power in an alternative modulation scheme, e.g. CDMA or FDMA, in a manner that would lower the average transmitter power, and thus reduce the size of hazard zone 250, consistent with ensuring adequate return channel uplink 170 energy was received at satellite 130 to effectuate a reliable communication link.

The threshold that disables transmission is any one of the following related conditions.

(a) When the input level drops below −65 dBm. As an example, for the Shannon terminal antenna that is located in Maryland, this is about 5 dB drop from the normal reception condition;

(b) When the bit error rate (BER) exceeds 2E⁻⁴.

The threshold depends on many factors, including the bit rates.

As one way of reducing the transmit duty cycle of transmitter 385, receiver 315 determines a signal quality indicator (SQI) which may indicate that the received signal is above a determined threshold value by setting an SQI flag in the control signal, or may provide a quantitative representation of the received signal level to control processor 350 via the control signal. When control processor 350 receives an indication that the signal quality is degraded, control processor 350 acts to reduce the bandwidth request rate of transmitter 385 through use of the bandwidth request signal provided between control processor 350 and modulator 360, as shown in FIG. 3. In TDMA implementations, for example, bandwidth increases as the number of time slots allocated in a transmit window to a particular remote station 140 increases. Because available spectrum for transmission is usually limited, a single return channel uplink (either 170a or 170b) is often shared between multiple users. Thus, the transmit window may then be shared between multiple remote stations 140, wherein the available time slots may be apportioned between the various shared users, usually depending on the traffic load, or other priority scheme, such as a precedence indicator associated with the uplink traffic. Conversely, as the number of time slots used in a transmit window decreases, the bandwidth necessary to accommodate the decreased number of time slots also decreases. As previously discussed in connection with TDMA implementations, for example, a decrease in bandwidth of the transmitted signal results in a reduction in the average power output of transmitter 385, which is then subsequently realized as a reduction in the size of hazard zone 250.

In a second aspect of the invention, detection of the intrusion of a human body or body parts into a prescribed auto-shutoff zone 260 is similarly accomplished by monitoring the received power level of control station downlink 120b. When the reduction in received power reaches a determined threshold level, the system disables transmitter 385 relatively quickly by triggering shutoff of the transmit power, typically in a fraction of a second. For example, the present invention preferably achieves an output power reduction of at least 50 dB within 25 microseconds. This reaction time depends on the control processor 350 employed in the demodulator 340, namely, the control processor 350 speed, the algorithm used in the control processor 350, and/or the reading speed of the control processor 350. This determined threshold level may be at a received signal level such that the received signal is completely unusable, and from which it may be presumed that near total blockage of the antenna has occurred, thus rendering the approach in the first aspect of the invention, i.e. reducing average transmitted power by reducing the transmitter duty cycle, relatively ineffective. Even if total blockage has not occurred, the present invention “fails safe” to ensure that humans are not potentially endangered by overexposure to RF energy at relatively high levels.

As a further factor of safety, auto-shutoff zone 260, which is determined by the reduction in received power level at which shutoff of transmitter 385 is triggered, may completely enclose hazard zone 250, to ensure absolute safety. In other words, auto-shutoff zone 260 may be constructed so that shutoff occurs if intrusion is detected in an area that has a power density level lower than the FCC-mandated maximum power density level.

There are several levels of hardware and software that may be used to fail-safe transmitter 385, and to automatically disable transmission should any one or more of the parameters utilized indicate degradation in performance.

For example, the system may determine and evaluate one or more of the following parameters, and disable transmitter 385 if one or more of the parameters indicate that the received signal in control station downlink 120b is degraded, and that it is likely that a foreign object, such as a human, may have intruded into either hazard zone 250 or auto-shutoff zone 260:

(1) Receive signal lock—Detects the presence of a received digital signal stream. This parameter may be measured by demodulator 340 at baseband, and could be, for example, related to signal-to-noise ratio (SNR). It may be represented by a number, e.g. between 0-100, or may simply indicate that the signal is above a threshold value.

(2) Demodulation lock (“demod lock”)—Indicates a loss of synchronization in receiver demodulator 340, and indicates the integrity of the digital signals. Loss of demodulation lock could be determined by a failure of the receiver to detect the presence of certain unique words or sequences in the received data stream, for example, a pseudorandom digital sequence, and loss of synchronization could be determined on a data frame basis.

(3) Intermediate Frequency Module IFM lock—Indicates the proper strength of the received signals.

(4) Frequency locked loop (FLL)—indicates that receiver 315 is properly synchronized to the received signal; or

(5) Bit-energy-to-noise ratio E_{b}/Nₒ—This ratio is determined and compared to a threshold value, below which the transmitter is disabled. This ratio may alternatively be converted to a signal quality indicator (SQI), with a relative value assigned between 0-100, for example. For E_{b}/Nₒ, there is no single threshold value, because E_{b}/Nₒ depends on many factors, such as the symbol rate, code rate, and the input level. For example, for symbol rate=30 Msps and code rate ¾, the threshold is E_{b}/Nₒ=4, and SQF=20.

These signal parameters may be measured, computed, or otherwise analyzed within receiver 315 using a receiver processor or other standard receiver circuitry (not shown), or may simply pass parameters via the control signal(s) between receiver 315 and control processor 350 so that control processor 350 performs the actual signal parameter analysis, and determines whether transmitter power should be disabled, and/or whether less bandwidth should be requested to reduce the average transmitter power.

All of the above fail-safe mechanisms may be set and fine-tuned in the design to tailor the size and sensitivity of auto-shutoff zone 260. When auto-shutoff zone 260 completely encloses hazard zone 250 for a prescribed minimum size of human body parts, the fail-safe automatic shutoff of transmitter 385, and therefore complete safety, may be achieved.

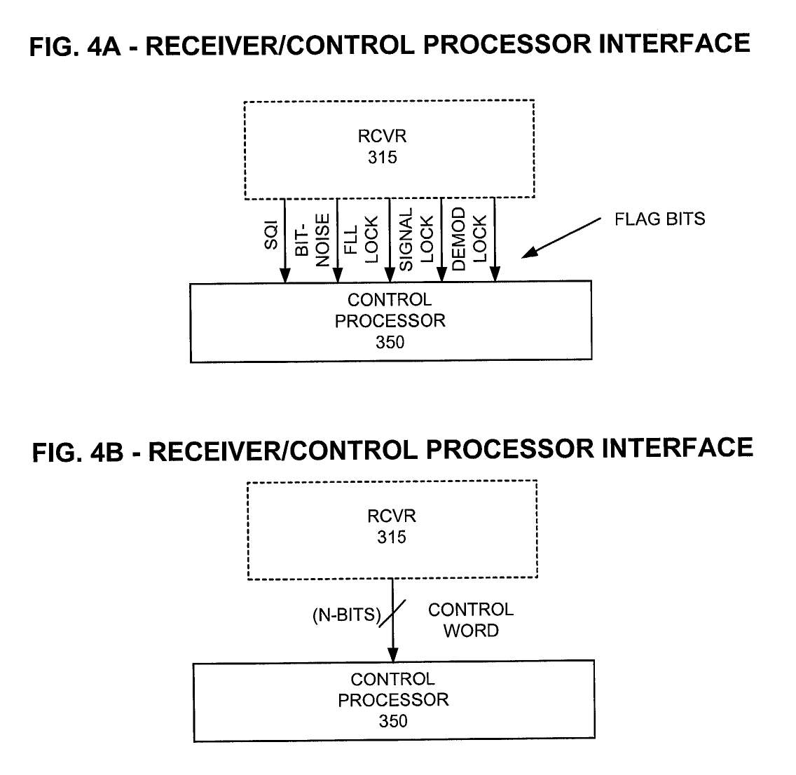

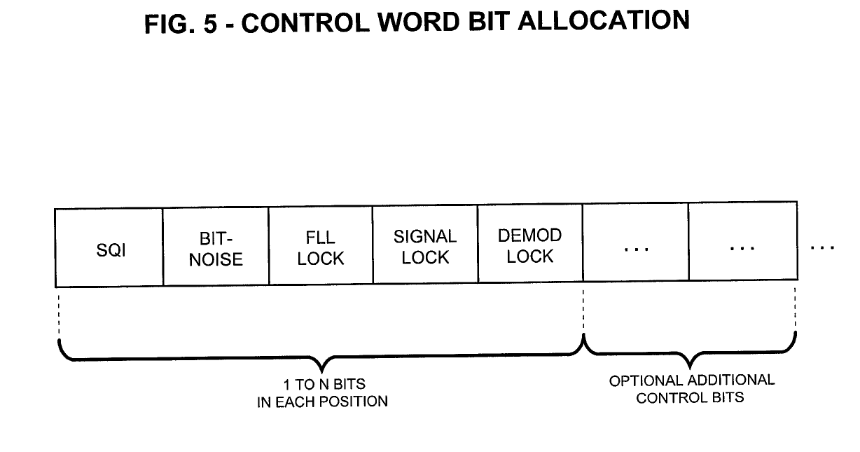

The control signal may be in the form of a “flag bit” (i.e. a “1” or “0”, or “go”/“no-go” indication), or a plurality of flag bits, each representing a condition of one of various signal parameters, as indicated in FIG. 4A. In a further embodiment, as shown in FIGS. 4B and 5, the control signal may be implemented as a control word having a multiple number of bits (1 to n) to simply represent either a flag bit as above, or a multiple number of bits, e.g. one or more bytes, to be able to provide finer gradations or numerical representations of the various signal parameters being analyzed.

Although discussion of a preferred embodiment of the present invention has been directed to a satellite communication system, the method and system of the present invention is not limited to such an implementation. For example, the present invention may also be applicable to other communication links, for example, a terrestrial point-to-point microwave communication could also benefit from the safety features added by the present invention.

It will be obvious that the present invention may be varied in many ways. Such variations are not to be regarded as a departure from the spirit and scope of the invention, and all such modifications as would be obvious to one skilled in the art are intended to be included within the scope of the following claims. The breadth and scope of the present invention is therefore limited only by the scope of the appended claims and their equivalents.

What is claimed is:

1. A system for controlling a hazardous RF emission zone of an antenna, comprising:
a receiver coupled to the antenna to process a received signal;
a control processor coupled to a first output of the receiver;
wherein the control processor controls the hazardous RF emission zone of the antenna by controlling an output power level of a transmitter in response to a control signal supplied by the first output of the receiver.

2. The system of claim 1, wherein the receiver includes a demodulator to provide the control signal which indicates one of a synchronized state and an unsynchronized state in the demodulator with respect to the received signal, and wherein the control processor disables the transmitter when the demodulator is in the unsynchronized state.

3. The system of claim 1, wherein the control processor provides a bandwidth request to the transmitter based on the control signal, and wherein the transmitter adjusts a transmitter duty cycle in response to the bandwidth request.

4. The system of claim 1, wherein the receiver detects the presence of said received signal and sets a flag bit in the control signal to indicate a loss of a received signal lock, and wherein said control processor disables the transmitter when the flag bit is set.

5. The system of claim 1, wherein the receiver measures a bit-to-noise energy ratio (E_{b}/Nₒ) of said received signal and compares the measured ratio to a threshold value, and wherein said control processor disables the transmitter when the measured ratio is less than the threshold value.

6. The system of claim 1, wherein the receiver provides a plurality of control signals to the control processor.

7. The system of claim 6, wherein the plurality of control signals each provides a status of a different control parameter.

8. The system of claim 7, wherein the control processor evaluates each of the plurality of different control parameters and reduces the output power level of the transmitter if any one of the different control parameters indicates an unacceptable degradation of the received signal.

9. The system of claim 7, wherein the plurality of control signals includes at least one of a signal presence indicator, a signal synchronization signal, a signal strength indicator, an FLL lock indication, and a bit-to-noise energy ratio (E_{b}/Nₒ) of said received signal.

10. The system of claim 9, wherein the plurality of control signals includes at least two of a signal presence indicator, a signal synchronization signal, a signal strength indicator, an FLL lock indication, and a bit-to-noise energy ratio (E_{b}/Nₒ) of said received signal.

11. The system of claim 10, wherein the plurality of control signals includes at least three of a signal presence indicator, a signal synchronization signal, a signal strength indicator, an FLL lock indication, and a bit-to-noise energy ratio (E_{b}/Nₒ) of said received signal.

12. The system of claim 11, wherein the plurality of control signals includes at least four of a signal presence indicator, a signal synchronization signal, a signal strength indicator, an FLL lock indication, and a bit-to-noise energy ratio (E_{b}/Nₒ) of said received signal.

13. The system of claim 12, wherein the plurality of control signals includes a signal presence indicator, a signal synchronization signal, a signal strength indicator, an FLL lock indication, and a bit-to-noise energy ratio (E_{b}/Nₒ) of said received signal.

14. The system of claim 1, wherein the control signal is a control word having a plurality of bits, wherein each bit of the plurality of bits represents a different indicator of a parameter of the received signal.

15. The system of claim 14, wherein the plurality of bits in the control word include at least one of a signal presence indicator, a signal synchronization signal, a signal strength indicator, an FLL lock indication, and a bit-to-noise energy ratio (E_{b}/Nₒ) of said received signal.

16. The system of claim 1, wherein the control signal provides a quantitative representation of the signal quality of the received signal to the control processor.

17. The system of claim 16, wherein the quantitative representation of the signal quality of the received signal is provided using a plurality of bits.

18. The system of claim 1, wherein the RF emission from the antenna is at a different frequency than the received signal.

19. A method for controlling a hazardous RF emission zone of an antenna, comprising:
measuring a signal received through an antenna;
evaluating the received signal; and
controlling a transmitter output power level based on the evaluation of the received signal, wherein the hazardous RF emission zone of the antenna is controlled by the transmitter output power level.

20. The method of claim 19, further comprising making a bandwidth request to the transmitter in response to the evaluation of a received signal strength, and wherein controlling the transmitter output power level is accomplished by controlling a transmitter duty cycle in response to the bandwidth request.

21. The method of claim 19, further comprising:
detecting one of a synchronized state and an unsynchronized state in a demodulator with respect to the received signal; and
disabling a transmitter when an unsynchronized state is detected in the demodulator.

22. The method of claim 19, further comprising providing a bandwidth request from a controller to the transmitter in response to the evaluation of a received signal strength, wherein controlling the transmitter output power level is accomplished by controlling a transmitter duty cycle in response to the bandwidth request.

23. The method of claim 19, wherein evaluating the received signal includes:
detecting a received signal lock in a receiver;
setting a flag bit in a control signal from the receiver to a processor when the received signal lock is not detected; and
disabling the transmitter when the flag bit is set.

24. The method of claim 19, wherein evaluating the received signal includes:
measuring a bit-to-noise energy ratio in a receiver;
comparing the bit-to-noise energy ratio to a threshold value; and
disabling the transmitter when the measured ratio is less than the threshold value.

25. The method of claim 19, wherein evaluating the received signal includes evaluating a plurality of signal parameters.

26. The method of claim 25, wherein controlling the transmitter output power level includes reducing the transmitter output power level if any one of the plurality of signal parameters indicates that the received signal is degraded below an acceptable level.

27. The method of claim 26, wherein the plurality of signal parameters includes a signal presence indicator, a signal synchronization signal, a signal strength indicator, an FLL lock indication, and a bit-to-noise energy ratio (E_{b}/Nₒ) of the received signal.

28. A satellite transceiver, comprising:
an antenna assembly including a reflector and a feedhorn;
a transmitter;
means for detecting intrusion of an object between the feedhorn and the reflector; and
a means for controlling a power level of the transmitter based on a detected intrusion.

29. An RF emission control device, comprising:
means for processing a signal received from an antenna;
means for adjusting a hazard zone associated with the RF emission,
wherein the means for adjusting a hazard zone adjusts the hazard zone based on an evaluation of at least one attribute of the received signal.

30. The device of claim 29, wherein the means for adjusting a hazard zone includes a processor providing a power-disabling control signal to a transmitter.

31. The device of claim 29, wherein the means for adjusting a hazard zone includes a processor providing a bandwidth request to a transmitter.

32. The device of claim 29, wherein the means for adjusting a hazard zone includes a processor which controls a duty cycle of a transmitter.

33. The device of claim 29, wherein the means for adjusting a hazard zone includes a processor which controls an average power output of a transmitter.

34. The device of claim 29, wherein the at least one attribute of the received signal includes a signal quality indicator of the received signal.

35. The device of claim 29, wherein the at least one attribute of the received signal includes an indication of a synchronization of a demodulator with the received signal.

36. The device of claim 29, wherein the means for processing a signal received from an antenna includes a TDMA receiver.
